(19) United States
(12) Patent Application Publication
(10) Pub. No.: US 2017/0358077 A1
(43) Pub. Date: Dec. 14, 2017

(54) METHOD AND APPARATUS FOR ALIGNING A TWO-DIMENSIONAL IMAGE WITH A PREDEFINED AXIS

(71) Applicants: AGENCY FOR SCIENCE, TECHNOLOGY AND RESEARCH, Singapore (SG); SINGAPORE HEALTH SERVICES PTE LTD, Singapore (SG)

(72) Inventors: Yanwu XU, Singapore (SG); Jiang LIU, Singapore (SG); Lixin DUAN, Singapore (SG); Wing Kee Damon WONG, Singapore (SG); Tin AUNG, Singapore (SG); Baskaran MANI, Singapore (SG); Shamira PERERA, Singapore (SG)

(73) Assignees: AGENCY FOR SCIENCE, TECHNOLOGY AND RESEARCH, Singapore (SG); SINGAPORE HEALTH SERVICES PTE LTD, Singapore (SG)

(21) Appl. No.: 15/541,337

(22) PCT Filed: Dec. 23, 2015
(86) PCT No.: PCT/SG2015/050505

§ 371 Date: Jun. 30, 2017

(30) Foreign Application Priority Data
Dec. 30, 2014 (SG) 10201408823W

(51) Int. Cl. G06T 7/00; G06T 3/00

(52) U.S. Cl. CPC G06T 7/0012; G06T 3/0068; G06T 2207/20182; G06T 2207/10101; G06T 2207/30041; G06T 2207/20224

(57) ABSTRACT

A method and apparatus for aligning a two-dimensional eye image with a predefined axis by rotation at a rotation angle are disclosed, the method comprising deriving the rotation angle and a de-noised image, which minimises a cost function comprising (i) a complexity measure of the de-noised image and (ii) magnitude of a noise image obtained by rotating the first image by the rotation angle and subtracting the de-noised image. Related methods and apparatus are disclosed for aligning a plurality of images with the predefined axis before alignments in transverse and parallel directions, as well as averaging the aligned images, in further embodiments, a method and apparatus of determining angle closure are disclosed, using a database of reference eye images with and without eye closure, the method comprising obtaining a two dimensional eye image, determining respective weights for each reference images that minimise a cost function comprising the difference between the received image and sum of the weighted reference images; identifying at least one of the first and second reference images having least differences with received image and determining whether the eye exhibits eye closure based on the received image being closer to first or second weighted reference images.

### TECHNICAL FIELD

The present disclosure relates to a method and apparatus for aligning a two-dimensional image with a predefined axis, such as, but is not limited to, aligning a two-dimensional optical coherence tomography (OCT) image of an eye of a subject with a predefined axis.

### BACKGROUND

Glaucoma is a group of heterogeneous optic neuropathies characterized by progressive loss of axons in the optic nerve. Data from WHO show that glaucoma accounts for 5.1 million of blindness in the world and is the second leading cause of blindness worldwide (behind cataract) as well as the foremost cause of irreversible blindness [1]. As the number of elderly in the world rapidly increases, glaucoma morbidity will rise, causing increased health care costs and economic burden. Since cataract is easily treated, glaucoma will become the most common cause of blindness in the world later this century with almost 70 million cases of glaucoma worldwide. More importantly, between 50-90% of people with glaucoma worldwide are unaware that they have the disease [2, 3].

Glaucoma is classified according to the configuration of the angle (the part of the eye between the cornea and iris mainly responsible for drainage of aqueous humor, as shown in FIG. 1(b)) into open angle and angle-closure glaucoma, as illustrated by FIGS. 1(a) and 1(c), respectively. Primary angle closure glaucoma (PACG) is a major form of glaucoma in Asia [4, 5], compared to primary open angle glaucoma (POAG), which is more common in Caucasians and Africans [6, 7]. This is true especially in populations of Chinese and Mongoloid descent [3, 8, 9]. Recent glaucoma prevalence studies in southern India found that the prevalence of PACG in Indians is also high [10, 11]. In China itself, it is estimated that PACG afflicts 3.5 million people and 28 million have a narrow drainage angle, which is the anatomical trait predisposing to PACG [4]. The disease is already responsible for the majority of bilateral glaucoma blindness in Mongolia [8], Singapore [9], China [3] and India [10, 11]. It is estimated that PACG blinds more people than POAG in relative terms, although the numbers of those with POAG worldwide is only 30% higher than PACG [12]. By 2020, PACG will affect 20 million people and amongst them, 5.3 million will be blind [13].

Angle closure results from obstruction of the trabecular meshwork by the iris, impeding the drainage of aqueous humour in the angle of the eye, causing an increase in intraocular pressure (IOP).

Previously reported anatomical risk factors for angle closure include a shallow central anterior chamber depth (ACD), a thick and anterior lens position and short axial length (AL) [14-17]. Amongst these, a shallow ACD is regarded as a sine qua non (cardinal risk factor) for the disease. However, population based data suggests that only a small proportion of subjects with shallow ACD ultimately develop PACG [18, 19]. Therefore, it is likely that other ocular factors are related to PACG development. The crystalline lens is thought to play a crucial role in the pathogenesis of angle closure disease due to either an increase in its thickness with age or a more anterior position which causes a decrease in ACD [15, 20-23]. This results in is angle crowding and a greater predisposition to pupillary block due to iridolenticular apposition in eyes with small anterior segments. Previous studies by the Singapore Eye Research Institute (SERI) have also shown that demographic factors identify high-risk groups. For example, women and Chinese have greater risk for angle closure [24, 25]. Recent studies by SERI investigated determinants of angle closure and found that while the most important independent determinants of angle closure were female gender, Chinese race, shorter AL and shallower ACD.

The inventors' previous work proposed several automated anterior chamber angle (ACA) assessment/classification methods. In particular, the methods involve feeding suggested clinical features, such as AOD500 [27] and Schwalbe's Line Bounded Area (SLBA) [28], or image features such as HOG [29, 30], BIF [30] and HEP [30] into pre-learned classifiers (e.g. linear SVM) for angle classification.

For example, an anterior chamber angle measurement method was described in [27]. In this method, the input ultrasound biomicroscopy (UBM) image is a converted binary image with a fix threshold value 128, and then a naïve method was used to detect the edge points of the anterior chamber angle by counting continuous 0 or 1 in each vertical line. Lastly, a line fitting is performed to obtain the two edges of the anterior chamber angle.

Another similar method was proposed in reference [28], but it works on high definition (HD) anterior segment optical coherence tomography (AS-OCT) images [28]. Firstly, the input gray-scale image was converted to a binary image with an adapt threshold. The cornea and the iris regions were then segmented by a connected component labeling segmentation method. This is followed by the detection of the Schwalbe's line by using linear regression and the SLBA is obtained.

In a further method, image features such as HOG [29, 30], BIF [30] and HEP [30] are fed into pre-learned linear SVM classifiers to perform angle classification. This image feature based machine learning approach has been shown to outperform traditional clinical feature based approaches. However, having tested on larger dataset, ACA localization based on complicated heuristics methods is not robust due to various kinds of imaging artifacts. The performance of ACA classification is also affected.

Therefore, it is desirable to have an improved method and apparatus which addresses one or more of the problems of the existing methods.

### SUMMARY

In general terms, the present invention proposes a method for aligning a two-dimensional image of an eye with a pre-defined axis by identifying values of a rotation angle and a de-noised image which minimize a cost function. The method may be used for aligning a plurality of images of an image sequence, such as multiple frames acquired during a scan video. This may allow misalignments caused by, for example, patient movements during the image acquisition to be compensated for. This allows for a “stabilized” 3-D rendered image (or 2D image) to be obtained for better visualization, localization and/or identification of anatomic structures, for example, an anterior chamber angle of an eye of a subject.

According to a first expression, there is provided a method of aligning a first two-dimensional image of an eye of a subject with a predefined axis. The method comprises identifying values of a rotation angle θ and of a de-noised image I⁰. These values minimise a cost function which comprises (i) a complexity measure of the de-noised image I⁰, and (ii) a measure of the magnitude of a noise image. The noise image is obtained by rotating the first image by the rotation angle and subtracting the denoised image. The first image is aligned with the predefined axis by rotating it by the identified rotation angle.

The method may be performed on a two-dimensional OCT image of an eye of a subject. The complexity measure of the de-noised image is a norm of the de-noised image. The measure of the magnitude of the noise image is the sum of the absolute values of the elements of the noise image.

According to a second expression, there is provided a method of aligning a plurality of images which are each a two-dimensional OCT image of an eye of a subject. The method comprises aligning the plurality of images with a predefined axis by a method described above. The method further includes aligning the images in a first direction transverse to the predefined axis. This is performed by determining a centre of symmetry axis in each image parallel to the predefined axis, and aligning the centres of symmetry axes. The method further includes aligning the images in a second direction parallel to the predefined axis by locating a landmark in each image, and aligning the positions of the landmarks in the second direction. The landmark may be, for example, the corneal ceiling of the eye image.

According to a third expression, there is provided a method of forming an average of a set of two-dimensional OCT images of an eye of a subject. The method comprises aligning the images by a method described above and forming an average of the aligned images.

Specifically, the above expression or a combination of them may achieve effective and efficient alignment for cross-sectional AS-OCT images. The various embodiments may be integrated into an OCT instrument. The embodiments may improve overall performance of ACA classification at a system level via enhanced mage stabilization, speckle reduction, accurate ACA localization and/or alignment.

There is also proposed a method for classifying a type of angle closure of the anterior chamber angle of an eye of a subject, for example, using the stabilized eye image obtained by any of the method described above. In preferred embodiments, the method classifies the subject as exhibiting primary angle closure glaucoma (PACG) or primary open angle glaucoma (POAG) using a similarity-weighted linear reconstruction (SWLR) method. Experimentally, the present inventors have shown that the SWLR method attains a higher ACA classification accuracy and overall efficiency than the existing methods.

According to another expression, there is provided a method of determining whether an eye of a subject exhibits angle closure. The method employs a database of reference images. Each reference image is a two-dimensional image of a corresponding eye and includes an intersection of an iris of the corresponding eye and a cornea of the eye. The reference images comprises first reference images for which the corresponding eyes are known to exhibit angle closure, and second reference images for which the corresponding eyes are known not to exhibit angle closure. The method includes receiving a two-dimensional image of a portion of the eye of the subject. The image is transverse to the lens of the eye and includes an intersection of an iris of the eye and a cornea of the eye. The method further includes determining respective weights for each of the reference images. The weights are chosen to minimise a cost function comprising the difference between the received image and a sum of the reference images weighted by the respective weights. The method further comprises identifying at least one of the first reference images having least difference with the received image, and at least one of the second references images having least difference with the received image. It is then determined whether the eye exhibits angle closure by determining whether the received image is closer to the identified first reference images weighted by the respective weight, or to the identified second reference images weighted by the respective weight.

The received image may be an image generated by any method described above. Since the received image has been “stabilized” by rotational adjustments (and optionally with vertical and horizontal adjustments too). The received images in combination with the above proposed classification method has been shown experimentally to produce robust results in ACA classification. In other words, the embodiment may provide a fully automated PACG detection system with high accuracy and robustness.

Preferably, an averaged image is obtained from the aligned images and a binarized image of the averaged image is obtained such that a location of an ACA vertex is identified from the binarized image. The received image is an image generated using the location of the ACA vertex.

According to a further expression, there is provided a computer system comprising a processor and a memory device configured to store program instructions operative, when performed by the processor, to cause the processor to perform any one of the methods described above.

The present invention may also be expressed as an apparatus configured to perform any one of the above methods. The apparatus is typically a computer system having appropriate hardware modules including a rotation adjustment module, an alignment adjustment module, a noise reduction module, and/or an angle-closure classification module configured to perform various relevant operations as described above with reference to the respective methods. It will be apparent to a skilled person in the art that the various hardware modules may be implemented by one or more computer processors that are in communication with memory devices storing program instructions. The memory devices may be, but is not limited to, random-access memory (RAM) and read-only memory (ROM). The one or more processors are configured to execute the program instructions so as to implement the functionality of the hardware modules. It is understood that by programming and/or loading executable instructions onto the computer system, at least one of the processors, the RAM, and the ROM are changed, transforming the computer system in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

In a preferred embodiment, the apparatus has the rotation adjustment module, the alignment adjustment module and the noise reduction module configured to perform some of the methods described above. This may be integrated into the AS-OCT machine to provide higher quality imaging output with speckle noise reduction and better 3D rendering of the imaging system.

In a preferred embodiment, the apparatus has the angle-closure classification module configured to perform some of the methods described above. In other words, a PACG detection system may be provided which is robust to noise, rotation and artifacts thereby achieving a high accuracy for anterior chamber angle classification. The PACG detection system can be used as an assistant diagnostic tool to be used in conjunction with UBM and/or OCT scanning machines.

According to yet a further expression, there is proposed a computer program product, such as a tangible recording medium. The computer program product stores program instructions operative, when performed by a processor, to cause the processor to perform any one of the methods described above.

It will be apparent to a skilled person in the art that various expressions of the present disclosure may be combined or performed independently of one and another.

### BRIEF DESCRIPTION OF THE DRAWINGS

Embodiments of the present invention will now be described for the sake of example only with reference to the following drawings, in which:

FIG. 1 is composed of FIG. 1(b) which shows the anterior chamber of an eye, and FIGS. 1(a) and 1(c) which illustrate the open angle and angle-closure glaucoma, respectively;

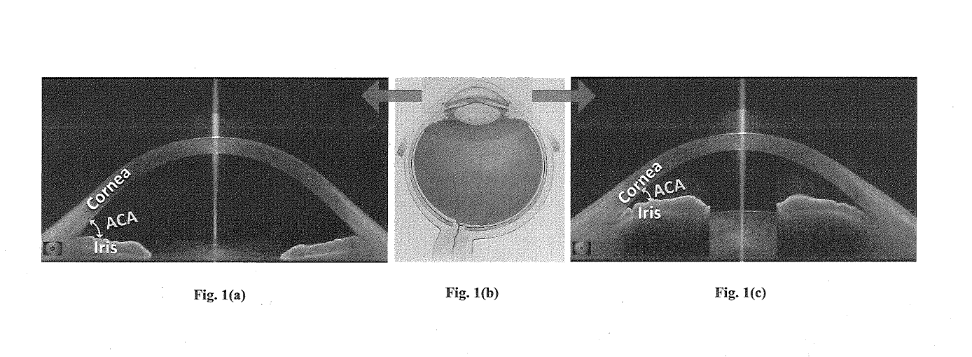

FIG. 2 is a flow diagram of an embodiment of the invention;

FIG. 3 is composed of FIG. 3(a) which shows AS-OCT images before and after corneal reflex artifact removal, FIG. 3(b) which shows AS-OCT images before and after the rotation adjustment, and FIG. 3(c) which shows averaged images before and after binarization;

FIG. 4, which is composed of FIGS. 4(a)-4(f), illustrate certain anatomical structures of the anterior segment of the eye, and FIGS. 4(a), 4(c), 4(d) and 4(f) also illustrate artifacts observed in the AS-OCT images; and

FIG. 5 includes a table and a graph comparing the performance in ACA classification between embodiments of the present invention and the existing methods.

### DETAILED DESCRIPTION

The embodiment will be illustrated with reference to two-dimensional OCT images of an eye, and specifically AS-OCT images, but it will be understood that the method is not limited to be performed with OCT images.

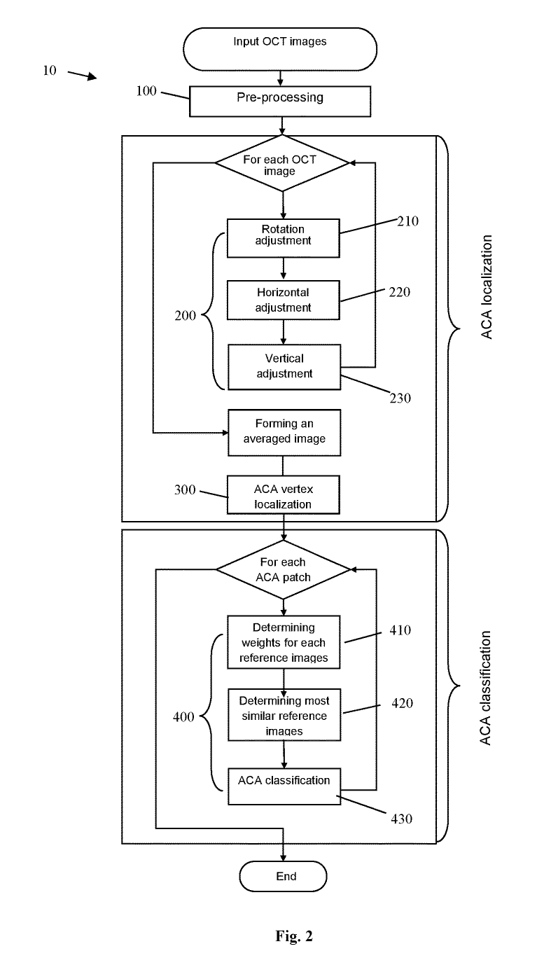

Referring to FIG. 2, a method 10 which is an embodiment of the invention is illustrated as a flow diagram. The method may be performed by a computer system. The computer system has one or more hardware modules configured to perform the method steps 100-400.

### Step 100: Preprocessing

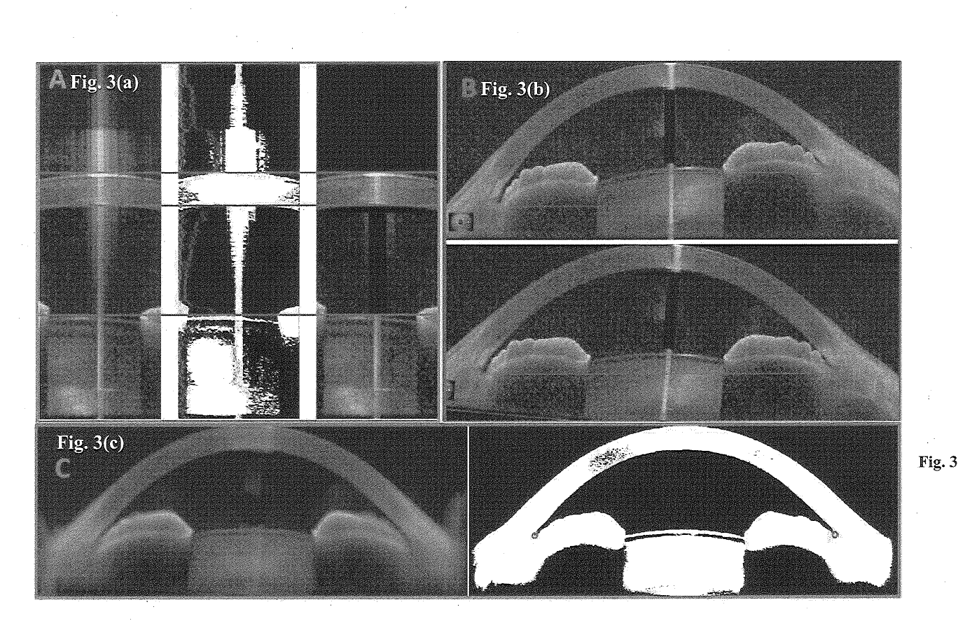

At step 100, preprocessing is performed to remove certain artifacts of the images. An OCT image often contains high-intensity vertical lines or segments around the central meridian, such as the one shown in the left image of FIG. 3(a). This is the reflection of the OCT flash (also known as the corneal reflex artifact) and it is generally perceived as a positive sign of the imaging quality (i.e. high quality) by clinicians. However, the corneal reflex artifact may affect image alignment and the anterior chamber angle localization. In step 100, this is partially removed using a simple filtering heuristic (but it may be added back to the aligned image for presentation to the clinicians to demonstrate a good imaging quality). In this example, the region is binarized with a threshold value to produce the image shown in the middle of FIG. 3(a). Based on a distribution profile of the number of the white pixels in each row, the locations of the cornea, anterior chamber and lens can be estimated. In this particular example, the top rows (i.e. the uppermost points of the boundary) of the cornea, anterior chamber and lens are roughly determined (as shown by the blue lines) based on the number of white pixels in each row (illustrated by red dots) and the difference between the number of white pixels in each row and those in the fifth row above it (illustrated by green dots). The long white segments above the cornea and within anterior chamber are then removed to produce the image as shown in FIG. 3(a) (right).

### Step 200: Image Alignment

In the embodiment illustrated in FIG. 2, step 200 comprises three sub-steps 210, 220, 230 in which The OCT image is adjusted for rotation and translational (such as vertical and/or horizontal) alignment. Step 200 may be performed for one single OCT image or a plurality of images of an image sequence. The example below is illustrated with reference to a set of AS-OCT images captured for a patient. It will be apparent that in case of a single image, the adjustment may be performed for rotation (sub-step 210) only, while translational adjustment (sub-steps 220, 230) may not be required.

The adjustment of a misaligned OCT image I to a recovered image I⁰ (also referred to as a de-noised image) with the correct position and orientation can be expressed as an affine transformation τ composed of a rotation θ, horizontal shift Δₓ and vertical shift Δ_{y}:

$$[ \begin{matrix}x \\ y\end{matrix} ] = [ \begin{matrix}cos θ & sin θ \\ - sin θ & cos θ\end{matrix} ] [ \begin{matrix}{x}^{′} \\ {y}^{′}\end{matrix} ] + [ \begin{matrix}{Δ}_{x} \\ {Δ}_{y}\end{matrix} ] , \qquad ( 1 )$$

where (x′, y′) represents the coordinate of the de-noised image I⁰, and (x, y) represents the coordinate of the misaligned OCT image I (i.e. the actual coordinate of the image I). To recover τ for each image, each of the three parameters (θ, Δₓ, Δ_{y}) are determined sequentially.

### (i) Sub-Step 210: Rotation Adjustment

Because of the symmetric structure of the anterior chamber, an image of it captured at the ideal, perfectly horizontal position should have a lower rank than any rotated version of the image.

Let us denote an OCT image as Iε [symbol] ^{m×n}, and a rotation of I by angle −θ as I^{θ}. Also, let I^{θ}=I⁰+E, where I⁰ε [symbol] ^{m×n} is a low-rank approximation of I^{θ}, and Eε [symbol] ^{m×n} models sparse noise and other artifacts.

To recover the rotation angle θ, the rotation adjustment is configured to solve for I⁰, E and θ as

$${min}_{θ , {I}^{0} , E} rank ( {I}^{0} ) + α {‖ E ‖}_{0} , s . t . {I}^{θ} = {I}^{0} + E , \qquad ( 2 )$$

where α>0 is a regularization parameter. In other words, the optimal values of the rotation angle θ and of a de-noised image I⁰, which a cost function is to be solved.

Since this optimization problem is NP-hard in general, its complex surrogate may be optimized instead, which has been shown to give a good approximation under fairly broad conditions [31]. This involves relaxing the rank(•) function to the matrix nuclear norm |•|_{*} (i.e., sum of all singular values), and the l₀-norm to the l₁-norm (i.e., the sum of absolute values of all entries), which yields the following objective function:

$${min}_{θ , {I}^{0} , E} {‖ {I}^{0} ‖}_{*} + α {‖ E ‖}_{1} , s . t . {I}^{θ} = {I}^{0} + E , \qquad ( 3 )$$

This problem can be efficiently solved with the TILT toolbox [32], which includes a pyramid acceleration strategy. An example of the resulting rotation adjustment is shown in FIG. 3(b), in which the bottom image is a rotation adjusted image of the top image. The rotation adjustment module performs rotation adjustment for each of the plurality of the OCT images, such that each of them is aligned with a predefined axis which allows them to be aligned with one and another.

### (ii) Sub-Step 220: Horizontal Adjustment

Once the rotationally-corrected image I^{θ} is recovered, its horizontal shift can be adjusted utilizing a symmetric property of the image. In particular, a translation adjustment module is configured to determine a vertical symmetry axis of each image and align the images by aligning their respective vertical symmetry axis. The vertical axis of symmetry can be found, for example, through the following search procedure:
1. Build a lookup table Sε [symbol] ^{n×n}, where sᵢⱼ=sⱼᵢ=(ρᵢ−ρⱼ)^{T}(ρᵢ−ρⱼ) is the l₂ distance between the i-th column ρᵢ and j-th column ρⱼ of image I^{θ}ε [symbol] ^{m×n};
2. Calculate the dissimilarity function Ψ(φ)=Σ_{I=1}^{h} s_{φ-l,φ+l} for each candidate symmetry axis

$$φ = \{ \frac{n + 1}{2} - ω , … , \frac{n + 1}{2} + ω \} ,$$

where wε

$$\{ 1 , … , \frac{n - 1}{2} \}$$

is a predefined search range, and hε

$$\{ 1 , … , \frac{n + 1}{2} - ω \}$$

is the chosen observation window width:
3. Determine the symmetrical center as φ*=arg min_{φ}Ψ(φ).

It will be apparent to a skilled person that other algorithms may be used to determine an axis of symmetry of the image. At the end of step 220, horizontal shifts may be corrected by aligning the axis of symmetry among the plurality of OCT images.

(iii) Sub-Step 230: Vertical Adjustment

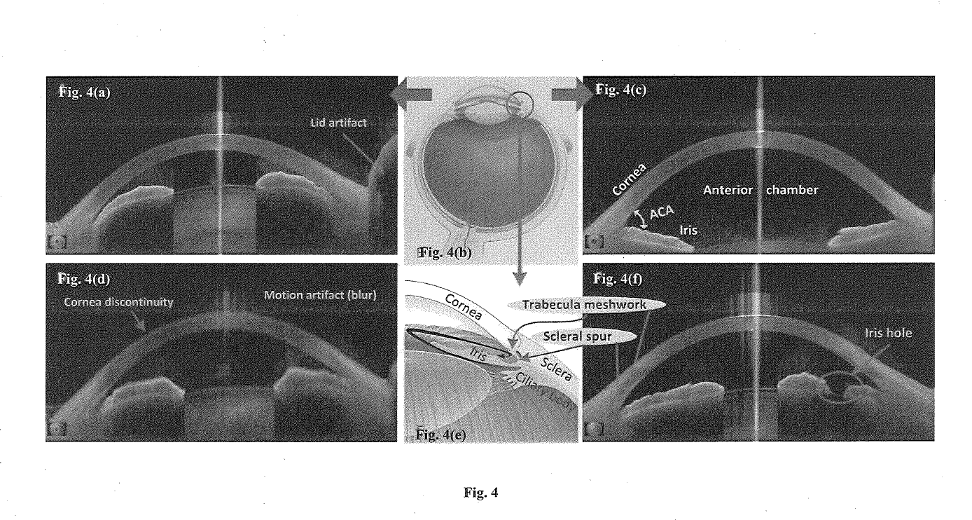

The alignment adjust module is configured to perform vertical alignment of the images by locating a landmark in each image and aligning the positions of the landmarks in the images. Ophthalmologists often use the scleral spur or trabecular network as a landmark for locating the ACA (FIG. 4(e)), but they can be hard to find in some images even for human experts. This example uses the corneal ceiling as the landmark for vertical alignment. The center of the corneal ceiling may be located using the method described the pre-processing step 100. Since misalignments are expected to be continuously smooth along the image sequence, the three parameters (θ, Δₓ, Δ_{y}) computed independently for each frame may each be processed by a three-frame smoothing filter for more robust alignment.

### Step 300: ACA Localization

In the exemplary embodiment, the ACA localization is performed using an averaged image of the plurality of the aligned images from step 200. This helps reduce the contribution of noises or artifacts which may affect the accuracy of ACA localization. The present inventors have found that it is advantageous to use an averaged image of the image sequence (e.g. a full circular OCT scan), since the averaged image should be relatively unaffected by artifacts (e.g. speckle noises) which are presumably randomly present in the individual OCT images. As a result, the averaged image achieves speckle noise reduction. A noise reduction module is configured to compute the averaged image using the aligned OCT images and the ACA is localized by identifying an ACA vertex as illustrated in the example below.

The aligned images may be binarized by thresholding and an averaged image is obtained as illustrated by FIG. 3(c). Although there may be differences in the shape of the iris among the respective OCT images, the boundaries of the anterior chamber have been shown to be fairly consistent. Overall, the average binarized image provides a clearer indication of where the ACA lies. In this embodiment, the ACA is found by identifying the center of the ceiling of the lens in a manner similar to that described in the preprocessing step 100. From the ceiling of the lens, a horizontal line is drawn to connect the lens and iris extending towards both sides. Enclosed above this line is the anterior chamber, whose bottom-left and bottom-right corners (typically located below the line) are the ACAs (i.e. two ACAs per eye of an subject). The anterior chamber area may be found by a simple flood fill procedure, and the ACA vertex may be located as the leftmost and rightmost points of the area, as described in [30] (the material of which is wholly incorporated by reference). Upon the ACA vertex being identified in the image, a sub-region of the image containing the ACA vertex or edge is obtained. An image patch of size 154×154 centered on the ACA vertex can be cropped at the corresponding location in each of the individual OCT images. The resulting localized ACA patches may be used in a subsequent classification stage as will be described with reference to step 400. It will be apparent to a skilled person that in a variant embodiment, the ACA patch of the averaged image may be used alone, or in combination with other patches of the respective OCT images of the image sequence for classification.

Note that the step 300 may be adapted for use with a single OCT image (i.e. without multiple frame information). It will be understood that for a single OCT image, the ACA vertex may be similarly identified from a binarized image of the image itself.

### Step 400: ACA Classification

At step 400, an angle-closure classification module is configured to determine whether an eye of a subject exhibits angle closure using a classification algorithm. According to a particular embodiment, a similarity-weighted linear reconstruction (SWLR) is used to determine whether the image of the subject more likely exhibits Primary angle closure glaucoma (PACG) or primary open angle glaucoma (POAG).

Step 400 employs a database of reference images. The reference images are divided into two sets, which comprise images which are known to exhibit angle closure and those are known not to exhibit angle closure, respectively. Each of the reference images is a two-dimensional image of a corresponding eye and includes an intersection of an iris of the corresponding eye and a cornea of the eye.

Step 400 comprises sub-steps 410-430 which are performed for each of the plurality of ACA patches (i.e. a portion or sub-portion of the eye image which includes at least an ACA vertex or edge). A cost function is employed which comprises the difference between the ACA patch and a weighted sum of the reference images (such as a reconstruction error described below). At sub-step 410, the weights for each of the reference images are determined such that the cost function is minimized. The reference images which have the least difference with the ACA patch is then selected from each of the two sets of reference images at sub-step 420. At sub-step 430, the classification module is configured to determine whether the ACA patch is closer to those identified reference images selected from the first set or those selected from the second set. Based on the comparison, the classification module determines whether the eye exhibits angle closure. Each of the sub-steps 410-430 are explained in more detail in the example below.

In this example, each ACA region is represented by an image patch of size 20×20. The ACA patches were downsized from 154×154 to 20×20 to reduce the effects of noise and slight misalignments between test and reference images (i.e. the “dictionary”). The image may be a gray scale or binary image.

In forming the reference image sets, each ACA image with a known classification (i.e. determined by an ophthalmologist) is used to produce a plurality of, for example, 9 reference images, in order to further accommodate misaligmnent among test and reference images. This is referred to as “dictionary expansion”. Specifically, in this example, each of the ACA patches of size 154×154 is first resized to 22×22, and from which 9 images of size 20×20 are obtained. The 9 images, which correspond to respective sub-regions of the 22×22 patch, are included as the reference images.

Suppose the dictionary consists of k reference images, denoted by D={d₁, d₂, . . . , dₖ}ε [symbol] ^{f×k} where each column dᵢ is a reference image expressed as a vector. For a given test image (e.g. a test ACA patch) gε [symbol] ^{f×1}, at sub-step 410, the classification module is configured to compute optimal linear reconstruction coefficients wε [symbol] ^{k×1}, |w|=1, that minimize the reconstruction error ∥g−Dw∥². The objective function may further include a similarity cost term that penalizes the use of references that are less similar to the test image. Let us denote the costs for the reference images in D as the vector c={c₁, c₂, . . . , cₖ}^{T}ε [symbol] ^{k×1}, where cᵢ is the cost of using dᵢ for reconstruction. The similarity cost term can then be expressed as ∥c⊙w∥² where ⊙ denotes the Hadamard product. Combining this cost term with the reconstruction error gives the following objective function:

$$arg {min}_{w} {‖ g - Dw ‖}^{2} + λ {‖ c ⊙ w ‖}^{2} , s . t . \vert w \vert = 1 , \qquad ( 4 )$$

where λ>0 is a regularization parameter. This objective function can be minimized in closed form using the Lagrange multiplier method, without the need for iterations:

$$w = \frac{1}{{1}^{⊤} ( {\hat{D}}^{⊤} \hat{D} + λ {C}^{⊤} C ) 1} {( {\hat{D}}^{⊤} \hat{D} + λ {C}^{⊤} C )}^{- 1} 1 , \hat{D} = ( 1 ⊗ g - D ) , \qquad ( 5 )$$

where C=diag(c) and [symbol] denotes the Kronecker product. For simplicity, we define in our implementation the cost cᵢ as the Gaussian distance between the test image g and the i-th reference image dᵢ, i.e.,

$${c}_{i} = exp ( \frac{{‖ g - {d}_{i} ‖}^{2}}{{σ}^{2 }} ) ,$$

where σ is a parameter that accounts for imaging noise. It will be appreciated by a skilled person that σ may be determined by cross-validation. For example, the optimal value of a is determined empirically by analyzing is a subset of the data (i.e. including some reference and test images) and validating using the rest of the data; typically, multiple rounds of cross-validation are performed using different subsets.

In this embodiment, the classification module classifies images to two classes D⁺ and D⁻ respectively representing POCG and POAG groups. For a given test image g, at sub-step 420, the k most similar reference images in each class (D⁺ and D⁻) are selected to reconstruct g. The most similar reference images may be identified based on the similarity cost c described above. For example, only references images each associated with a similarity cost c which is below a cut-off value are chosen. Typically, the reconstruction error is also minimized at the same time so as to achieve the minimum objective value. After identifying the optimal reconstruction coefficients w⁺ and w⁻ for D⁺ and D⁻, respectively, the classification module is configured to compute the difference in reconstruction errors for the two classes,

ψ(g)=∥g−D⁻w⁻∥²−∥g−D⁺w⁺∥², (6)

as the decision value for classification, i.e., g is classified as angle-closure when ψ(g)≧0, and is otherwise classified as open-angle.

### Advantages of the Embodiments of the Present Invention

The present inventors have found that the ACA classification performance is mainly influenced by (1) ACA localization accuracy and (2) ACA labeling/assessment accuracy of the reference data set (i.e. the ground truth labeling by the ophthalmologist, which is subject to inter-subject variability). While both tasks are challenging, the first step has a directly impact on the accuracy of the second step. This is due to the relative large rotation of the eyeball during the imaging process and also due to various artifacts, such as speckle noise, corneal reflex, corneal breaks (e.g. those caused by eyelash shadows), iris holes (e.g. from laser surgery), motion blur, and eye lid intrusion, as illustrated by FIGS. 4(a)-4(f). Better alignment of the image sequence enhances the input image of the second step thereby improving the accuracy of the ACA classification.

Different from the previous work [29, 30] which extracts visual features from an ACA patch for classification, the embodiments of the present invention take a reconstruction-based approach, which has been shown to yield higher accuracy.

The performance of embodiments of the invention are assessed and compared with other existing methods. The results have demonstrated that the embodiments of the present invention are able to achieve significant improvements over the existing methods. Table 1 below provides a summary of limitations of existing methods.

| | Method 1: [27] | Method 2: [28] | Method 3: [30] |
|---|---|---|---|
| Test dataset | 69 images | 10 images | 8 × 128 = |
| | | | 1024 images |
| Features/Key | AOD500, | SLBA, | HEP, |
| technology | Edge Detection | Segmentation and | image feature based |
| | and Line Fitting | Edge Detection | linear classification |
| Limitations | 1) very sensitive | 1) only about 90% | 1) ACA localization |
| | to noise, 12% of | images have | is based on single |
| | the test dataset | distinct Schwalbe's | image and its |
| | failed to detect | line; | accuracy reduces |
| | the edges; | 2) only work with | when eyeball having |
| | 2) angle | HD AS-OCT | large rotation; |
| | measurement | images; | 2) ACA |
| | accuracy is | 3) only the | classification |
| | not available, | accuracy | accuracy is also |
| | and the | of Schwalbe's | influenced by |
| | performance | line | misalignment |
| | for angle | detection | |
| | classification is | is reported, | |
| | also not | while the | |
| | available. | performance for | |
| | | angle | |
| | | classification | |
| | | is not | |
| | | available. | |

Images were collected using AS-OCT machine CASIA SS-1000 from Tomey Ltd. (Japan), which provided a 360 degree circular scan of up to 128 cross-sectional images of the anterior chamber in 0.3-2.4 s. Compared to existing methods which uses a single image (which was also collected using the above machine), the present method utilizes the relationship of a sequence of cross-sectional images which provide more information to achieve high accuracy.

The present method was implemented in Matlab and tested on a four-core 3.2 GHz PC with 24 GB RAM. A total of 3840 OCT images (i.e. with 7680 ACAs) are used for experimentation. The images are obtained from circular scan videos, each with 128 frames, of 30 patients' eyes, 16 of which with primary angle-closure glaucoma (PACG) and the other 14 with primary open-angle glaucoma (POAG). The tests are performed by classifying each individual ACA, with the ground truth label provided by a senior ophthalmologist. The ground truth label represents the correct classification.

### (a) Improvement on ACA Localization

In terms of localization accuracy, the method of [30] fails in 16 videos, which is equivalent to 5.72% failure in total. The method of [29] fails in 10 videos, i.e. in total 3.49% ACAs are not localized accurately. For the embodiments of the present invention, all ACAs are localized accurately.

In terms of speed, the method of [30] takes 0.4 s per image (2 angles), while the present method method takes 1.2 s per image. This is mainly due to the alignment steps (i.e. rotation and translational adjustments). This is three times slower but provides more robust results in both ACA localization as well as ACA classification as will be described later.

### (b) Improvement on ACA Classification

In the classification comparison, all ACAs are localized with the embodiment of the present invention, for fair comparison. To evaluate classification accuracy, we perform five rounds of tests. In each round, images from six of the patients are used for testing while the others are used for training. To balance between PAOG and PACG, one of the rounds has 4 PACG and 2 POAG for testing, and the others have 3 PACG and 3 POAG each. We assess performance using the same metrics as in [29, 30], namely balanced accuracy (P̅) with a fixed 85% specificity (P_), and area under ROC curve (AUC) as defined in [30], which are listed below. These are considered the most common criterion used in evaluating the overall performance.

$$\overline{P} = \frac{{P}_{+} + {P}_{-}}{2} , {P}_{+} = \frac{TP}{TP + FN} , {P}_{-} = \frac{TN}{TN + FP} , \qquad ( 4 )$$

where TP and TN denote the number of true positives and negatives, respectively, and FP and FN denote the number of false positives and negatives, respectively.

Since our previous work [29] and [30] show great improvement of image feature based classification over clinical feature based approaches, in this work, we compare with the method of [29], [30] and several reconstruction-based methods, excluding the clinical feature based methods.

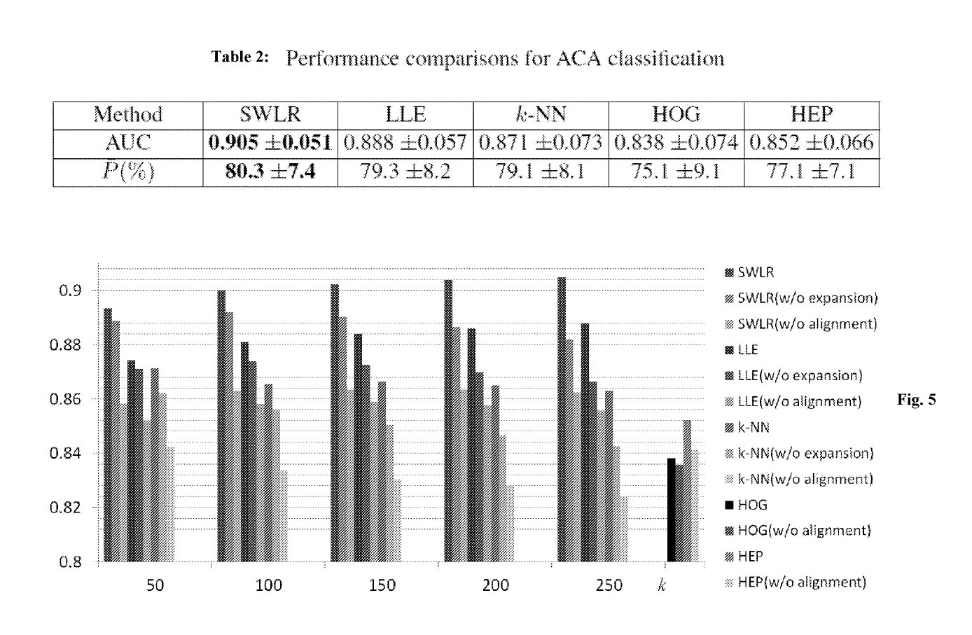

Our ACA classification comparison includes five methods, namely SWLR, LLE, k-NN, HOG [29] and HEP [30]. SWLR (similarity-weighted linear reconstruction) refers to the proposed reconstruction method with a similarity cost (i.e. λ≠0 in Eq.(4)). LLE (locally linear embedding) refers to the proposed reconstruction method without the cost constraint (i.e. λ=0 in Eq.(4)). k-NN (k-nearest neighbors) uses only the similarity cost computed as the sum of the k smallest distances to the test image from each class. HOG and HEP refer to linear SVM classification with HOG and HEP features, respectively. For HOG and HEP feature extraction, the optimal parameters reported in [29] and [30] are used. We also use the optimal parameters found for SWLR (k=250, σ=1, λ=100), LLE (k=250), and k-NN (k=50, σ=1). The results, as shown in FIG. 5 (Table 2), have demonstrated the following:
1. Reconstruction-based methods (SWLR, LLE and k-NN) have higher accuracy than visual feature based classification methods, and
2. Among the reconstruction-based methods, SWLR which considers both reconstruction error and similarity, has the highest accuracy, outperforming LLE which does not consider similarity and k-NN which accounts for similarity only.

Overall, the improvement of the PACG detection using the embodiment is more significant, comparing with using the ACA localization algorithms described in the previous work [29, 30].

### (c) Other Observations

### (i) Influence of Parameter k

The parameter k affects the accuracy and speed of all of the reconstruction-based methods. As shown in FIG. 5, the accuracy of SWLR and LLE increases slightly with a larger k. On the other hand, k-NN drops in performance with a larger k, because less relevant reference samples are introduced into the cost. Within the range of tested k values, the time cost of SWLR and LLE increases almost linearly with k, while the speed of k-NN does not depend on k. For the highest accuracy obtained when k=250, SWLR and LLE cost 0.031 s and 0.027 s per image, while k-NN, HOG and HEP cost 0.009 s, 0.014 s and 0.007 s per image, respectively. All of the classification methods are computationally efficient in comparison to ACA localization.

### (ii) Validation of Rotation Adjustment

As shown in FIG. 5, reconstruction-based methods have a certain degree of sensitivity to rotational misalignment, and the performance dropped 2.24-4.25% when this component is removed. By contrast, the HOG features are not affected as much (0.25% drop) because the angular quantization in HOG representation provides rotation invariance to a certain extent. These results demonstrated that the limitations associated with reconstruction-based approaches can be compensated for by rotational adjustment and optionally with translational adjustment proposed by the present methods.

(iii) Validation of Dictionary Expansion

In FIG. 5, it is shown that dictionary expansion leads to a 0.46-2.28% improvement for reconstruction methods. This is likely due to better translational alignment between reference and test images, which helps further improves the ACA classification accuracy through reconstruction approaches.

Whilst the foregoing description has described exemplary embodiments, it will be understood by those skilled in the art that many variations of the embodiment can be made within the scope and spirit of the present invention. For example, the proposed method is not only suitable to process image sequences but also works well on a single image. For another example, the present invention may be used for diagnosis of other eye diseases.

### REFERENCES

[1] Thylefors B, Negrel A D, Pararajasegaram R, Dadzie K Y. Global data on blindness. Bull WHO 1995; 73(1): 115-21
[2] Sathyamangalam R V, Paul P G, George R, et al. Determinants of glaucoma awareness and knowledge in urban Chennai. Indian J Ophthalmol. 2009t; 57:355-60.
[3] Foster P J, Oen F T, Machin D, Ng T P, Devereux J G, Johnson G J, Khaw P T, Seah S K. The prevalence of glaucoma in Chinese residents of Singapore: a cross-sectional population survey of the Tanjong Pagar district. Arch Ophthalmol 2000; 118:1105-11
[4] Hu Z, Zhao Z L, Dong F T. An epidemiological investigation of glaucoma in Beijing and Shun-Yi county. Chin J Ophthalmol 1989; 25: 115-8
[5] Foster P J, Johnson G J. Glaucoma in China: how big is the problem? Br J Ophthalmol 2001; 85: 1277-82
[6] Tielsch J M, Sommer A, Katz J, Royall R M, Quigley H A, Javitt J. Racial variations in prevalence of primary open angle glaucoma. JAMA 1991; 266: 369-74
[7] Klein B E, Klein R, Sponsel W E, Franke T, Cantor L B, Martone J, Menage M J. Prevalence of glaucoma. The Beaver Dam Eye Study. Ophthalmology 1992; 99: 1499-1504
[8] Congdon N, Wang F, Tielsch J M: Issues in the epidemiology and population based screening of primary angle-closure glaucoma. Sury Ophthalmol 1992; 36: 411-423
[9] Foster P J, Baasanhu J, Alsbirk P H, Munkhbayar D, Uranchimeg D, Johnson G J. Glaucoma in Mongolia-a population-based survey in Hovsgol Province, Northern Mongolia. Arch Ophthalmol 1996; 114: 1235-41
[10] Dandona L, Dandona R, Mandal P, Srinivas M, John R K, McCarty C A, Rao G N. Angle closure glaucoma in an urban population in Southern India. The Andhra Pradesh Eye Disease Study. Ophthalmology 2000; 107: 1710-6
[11] Jacob A, Thomas R, Koshi S P, Braganza A, Muliyil J. Prevalence of primary glaucoma in an urban south Indian population. Indian J Ophthalmol 1998; 46: 81-6
[12] Quigley H A, Congdon N G, Friedman D G. Glaucoma in China (and worldwide): changes in established thinking will decrease preventable blindness. Br J Ophthalmol 2001; 85:1271-1272
[13] Quigley H A, Broman A T. The number of people with glaucoma worldwide in 2010 and 2020. Br J Ophthalmol 2006; 90: 262-7
[14] Congdon N G, Youlin Q, Quigley H, et al. Biometry and primary angle-closure glaucoma among Chinese, white, and black populations. Ophthalmology 1997; 104:1489-95.
[15] Lowe R F. Aetiology of the anatomical basis for primary angle closure glaucoma: biometrical comparisons between normal eyes and eyes with primary angle-closure glaucoma. Br J Ophthalmol 1970; 54:161-9.
[16] Sihota R, Lakshmaiah N C, Agarwall H C, et al. Ocular parameters in subgroups of angle closure glaucoma. Clin Experiment Ophthalmol 2000; 28:253-8.
[17] George R, Paul P G, Baskaran M, et al. Ocular biometry in occludable angles and angle closure glaucoma: a population based survey. Br J Ophthalmol 2003; 87:399-402.
[18] Wang N L, Wu H P, Fan Z G. Primary angle closure glaucoma in Chinese and Western populations. Chinese Medical Journal 2002; 115:1706-15.
[19] Alsbirk P H. Anatomical risk factors of angle-closure glaucoma. A 10-year study of limbal and axial anterior chamber depth in a risk population. Ugeskr Laeger 1994; 156:5117-21.
[20] Tomlinson A, Leighton D A. Ocular dimensions in the heredity of angle-closure glaucoma. Br J Ophthalmol. 1973; 57:475-86.
[21] Salmon J F, Swanevelder S A, Donald M A. The Dimensions of Eyes with Chronic Angle-closure Glaucoma. J Glaucoma. 1994; 3:237-43.
[22] Marchini G, Pagliarusco A, Toscano A, et al. Ultrasound biomicroscopic and conventional ultrasonographic study of ocular dimensions in primary angle-closure glaucoma. Ophthalmology. 1998; 105:2091-8.
[23] Sihota R, Ghate D, Mohan S, et al. Study of biometric parameters in family members of primary angle closure glaucoma patients. Eye 2008; 22:521-7.
[24] Aung T, Nolan W P, Machin D, et al. Anterior chamber depth and the risk of primary angle closure in 2 East Asian populations. Arch Ophthalmol 2005; 123:527-32
[25] Foster P J, Aung T, Nolan W P, et al. Defining “occludable” angles in population surveys: drainage angle width, peripheral anterior synechiae, and glaucomatous optic neuropathy in east Asian people. Br J Ophthalmol 2004; 88:486-90.
[26] Lavanya R, Wong T Y, Friedman D S, et al. Determinants of angle closure in older Singaporeans. Arch Ophthalmol 2008; 126:686-91.
[27] Leung C K, Yung W H, Yiu C K, Lam S W, Leung D Y, Tse R K, Tham C C, Chan W M, Lam D S. Novel approach for anterior chamber angle analysis: anterior chamber angle detection with edge measurement and identification algorithm (ACADEMIA). Arch Ophthalmol 2006, 124(10):1395-401.
[28] Tian J, Marziliano P, Wong H T. automatic detection of Schwalbe's line in the anterior chamber angle of the eye using H D-OCT images. In Proc. 32nd Annual International Conference of the IEEE Engineering in Medicine and Biology Society, 2010:3013-16.
[29] Xu Y, Liu J, Tan N M, Lee B H, Wong D, Baskaran M, Perera S, Aung T. Anterior Chamber Angle Classification Using Multiscale Histograms of Oriented Gradients for Glaucoma Subtype Identification. In Proc. 34th Annual International Conference of the IEEE Engineering in Medicine and Biology Society, 2012:3167-70.
[30] Xu Y, Liu J, Tan N M, Lee B H, Wong D, Baskaran M, Perera S, Aung T Automated Anterior Chamber Angle Localization and Glaucoma Type Classification in OCT Images. In Proc. 35th Annual International Conference of the IEEE Engineering in Medicine and Biology Society, 2013:7380-3.
[31] Candès E J, Li X, Ma Y, Wright J. Robust principal component analysis? Journal of the ACM, 2011; 58(3): Article 11.
[32] Zhang Z, Ganesh A, Liang X, Ma Y. TILT: Transform Invariant Low-Rank Textures International Journal of Computer Vision, 2012; 99(1):1-24.

1. A method of aligning a first two-dimensional image of an eye of a subject with a predefined axis, the method comprising:
identifying values of a rotation angle θ and of a de-noised image I⁰, which minimise a cost function, said cost function comprising (i) a complexity measure of the de-noised image I⁰, and (ii) a measure of the magnitude of a noise image which is obtained by rotating the first image by the rotation angle and subtracting the denoised image;
the first image being aligned with the predefined axis by rotating it by the identified rotation angle.

2. A method according to claim 1 in which the complexity measure of the de-noised image is a norm of the de-noised image.

3. A method according to claim 1 in which the measure of the magnitude of the noise image is the sum of the absolute values of the elements of the noise image.

4. A method according to claim 1, the first a two-dimensional image is a two-dimensional optical coherence tomography (OCT) image.

5. A method of aligning a plurality of images which are each a two-dimensional OCT image of an eye of a subject, the method comprising:
aligning the plurality of images with a predefined axis by a method according to claim 1;
aligning the images in a first direction transverse to the predefined axis, by determining a centre of symmetry axis in each image parallel to the predefined axis, and aligning the centres of symmetry axes; and
aligning the images in a second direction parallel to the predefined axis by locating a landmark in each image, and aligning the positions of the landmarks in the second direction.

6. A method of forming an average of a set of two-dimensional OCT images of an eye of a subject, the method comprising:
aligning the images by a method according to claim 5; and
forming an average of the aligned images.

7. A method of determining whether an eye of a subject exhibits angle closure,
the method employing a database of reference images, each reference image being a two-dimensional image of a corresponding eye and including an intersection of an iris of the corresponding eye and a cornea of the eye, the reference images comprising first reference images for which the corresponding eyes are known to exhibit angle closure, and second reference images for which the corresponding eyes are known not to exhibit angle closure;
the method including:
(i) receiving a two-dimensional image of a portion of the eye of the subject, the image being transverse to the lens of the eye and including an intersection of an iris of the eye and a cornea of the eye;
(ii) determining respective weights for each of the reference images, the weights being chosen to minimise a cost function comprising the difference between the received image and a sum of the reference images weighted by the respective weights;
(iii) identifying at least one of the first reference images having least difference with the received image, and at least one of the second references images having least difference with the received image; and
(iv) determining whether the eye exhibits angle closure by determining whether the received image is closer to the identified first reference images weighted by the respective weight, or to the identified second reference images weighted by the respective weight.

8. A method according to claim 7 in which the received image is an image generated by a method according to claim 1.

9. A method according to claim 7 in which the received image is generated using a feature of the eye of the subject; said feature being identified using a binarized image of the image generated by a method according to claim 1.

10. A method according to claim 9 in which the feature of the eye of the subject is an anterior chamber angle (ACA) vertex of the eye.

11. A computer system comprising a processor and a memory device configured to store computer-readable instructions operative, when performed by the processor, to cause the processor to perform a method according to claim 1.

12. A non-transitory computer-readable storage medium storing computer-readable instructions operative, when performed by a processor, to cause the processor to perform a method according to claim 1.

13. An apparatus for aligning a first two-dimensional image of an eye of a subject with a predefined axis, the apparatus comprising a rotation adjustment module which is configured to:
identify values of a rotation angle θ and of a de-noised image I⁰, which minimise a cost function, said cost function comprising (i) a complexity measure of the de-noised image I⁰, and (ii) a measure of the magnitude of a noise image which is obtained by rotating the first image by the rotation angle and subtracting the denoised image;
the first image being aligned with the predefined axis by rotating it by the identified rotation angle.

14. An apparatus for aligning a plurality of images which are each a two-dimensional OCT image of an eye of a subject, the apparatus comprising an alignment adjustment module which is configured to:
align the plurality of images with a predefined axis using a rotation adjustment module according to claim 13;
align the images in a first direction transverse to the predefined axis, by determining a centre of symmetry axis in each image parallel to the predefined axis, and aligning the centres of symmetry axes; and
align the images in a second direction parallel to the predefined axis by locating a landmark in each image, and aligning the positions of the landmarks in the second direction.

15. An apparatus for forming an average of a set of two-dimensional OCT images of an eye of a subject, the apparatus comprising a noise reduction module which is configured to:
align the images using an alignment adjustment module according to claim 14; and
form an average of the aligned images.

16. An apparatus for determining whether an eye of a subject exhibits angle closure, the apparatus employing a database of reference images, each reference image being a two-dimensional image of a corresponding eye and including an intersection of an iris of the corresponding eye and a cornea of the eye, the reference images comprising first reference images for which the corresponding eyes are known to exhibit angle closure, and second reference images for which the corresponding eyes are known not to exhibit angle closure; the apparatus comprising an angle-closure classification module which is configured to:
(i) receive a two-dimensional image of a portion of the eye of the subject, the image being transverse to the lens of the eye and including an intersection of an iris of the eye and a cornea of the eye;
(ii) determine respective weights for each of the reference images, the weights being chosen to minimise a cost function comprising the difference between the received image and a sum of the reference images weighted by the respective weights;
(iii) identify at least one of the first reference images having least difference with the received image, and at least one of the second references images having least difference with the received image; and
determine whether the eye exhibits angle closure by determining whether the received image is closer to the identified first reference images weighted by the respective weight, or to the identified second reference images weighted by the respective weight.
